(19) United States
(12) Patent Application Publication
(10) Pub. No.: US 2006/0244174 A1
(43) Pub. Date: Nov. 2, 2006

(54) Advanced method and apparatus for cost-effectively and continuously producing expanded thermoformable honeycomb materials

(75) Inventors: Thomas St. Denis, Rowayton, CT (US); Gabe Karamanis, Stamford, CT (US)

Correspondence Address: Paul D. Greeley;Ohlandt, Greeley, Ruggiero & Perle, L.L.P., One Landmark Square, 10th Floor, Stamford, CT, 06901-2682, US

(73) Assignee: Panterra Engineered Plastics, Inc.

(21) Appl. No.: 11/413,507

(22) Filed: Apr. 28, 2006

Related U.S. Application Data
(60) Provisional application No. 60/676,405, filed on Apr. 29, 2005.

(51) Int. Cl. B29C 47/00

(52) U.S. Cl. 264/210.2; 425/4 C

(57) ABSTRACT

A method for continuously and cost-effectively producing expanded thermoformable honeycomb materials comprising the steps of: providing raw thermoformable thermoplastic material (such as flakes or pellets) into an extruder; heating the material in the extruder; extruding the continuous sheet material to a suitable gauge and width; trimming the extruded material while it is still hot to desired widths; conveying this hot thermoformable, continuous sheet into a preheat/heating section comprised of either hot forming rolls or belts; heating the thermoformable continuous sheet on forming rolls or between continuous forming belts that have specific geometries machined on the surfaces; adhering the continuous sheet on the forming surfaces by hot tack adhesion; expanding the continuous sheet into expanded honeycomb by separating the forming surfaces so as to effect an expansion of the cross-section of the thermoformable continuous sheet material; transferring the expanded honeycomb through an array of cooling rolls or belts thereby cooling the expanded honeycomb thereby maintaining its integrity and facilitating its release from the exit of the cooling region.

### CROSS-REFERENCED APPLICATIONS

This application claims priority from U.S. Provisional Patent Application No. 60/676,405, filed on Apr. 29, 2005.

### BACKGROUND OF THE INVENTION

1. Field of the Invention

The present invention relates to an advanced method and apparatus for producing expanded, thermoformable honeycomb materials by forming the structures in a cost-effective, energy efficient and continuous processing manner.

2. Description of the Prior Art

Typically, processes used to manufacture expanded thermoformable honeycomb materials involve placing a thermoformable, thermoplastic polymeric material sheet between mold platens, which are attached to a heated press. The thermoformable, thermoplastic, polymeric material sheet is heated to a specific temperature at which the thermoformable material will adhesively bond to the mold platens through a hot tack adhesion mechanism. The mold platens are than separated apart with the thermoformable material adhering to the mold platens so as to affect an expansion of the cross-section of the thermoformable, thermoplastic sheet material.

Usually, the surfaces of the mold platens that are bonded to the thermoplastic material sheet have a number of perforations across the entire area. The thermoplastic material will adhesively bond to the non-perforated portion of this surface so that when the mold plates are separated apart, a number of honeycomb cells will be formed within the cross-section of the expanded thermoformable material. Generally, these perforations can have a variety of different geometries and can be arranged in an array of patterns on the surface of the mold platens, thereby creating thermoformable materials having a variety of cross-sectional geometries. Such methods for expanding thermoformable materials are set forth in U.S. Pat. No. 6,322,651 (Phelps) issued Nov. 27, 2001, U.S. Pat. No. 4,113,909 (Beasley), issued Sep. 12, 1978, U.S. Pat. No. 4,164,389 (Beasley), issued Aug. 14, 1979, U.S. Pat. No. 4,315,051 (Rourke), issued Feb. 9, 1982, U.S. Pat. No. 4,269,586 (Ronayne), issued May 26, 1981, U.S. Pat. No. 4,264,293 (Rourke), issued Apr. 28, 1981, and U.S. Pat. No. 4,315,050 (Rourke), issued Feb. 9, 1982, each of which is incorporated herein by reference.

Related problems are large economic losses due to the use of separate extruded sheet that is processed into the expanded, thermoformable honeycomb material in a batch or semi-continuous manner. Extruded sheet is made from thermoplastic flake or pellets which are heated to a high temperature to cause it to melt and be formed through dies under pressure. After extrusion from the dies, the sheet material is polished to give it a good finish, cooled, sealed and cut. Then it is stored and eventually transported to the coreformer where it must be unsealed and reheated before being formed into expanded honeycomb. The process of expanding the honeycomb destroys the polish that the sheet had been given by the original extrusion process.

In addition, the cost of production is substantially increased because of the amount of wasted energy in these conventional processes. Each thermoformable sheet material must be reheated using new energy due to the fact that all of the energy from the original heating of the resin in the extruder is lost and the sheet material has to be re-heated. The current methods require the material of the expanded core to be cooled twice, once after extrusion and once after expansion. Thus, the cost of production is increased because new energy must be purchased to heat each new sheet of thermoformable material that is to be expanded and all of such energy is wasted during the initial cooling process.

A further disadvantage of the previous methods is that the thermoformable sheet material used for the expansion process has internal stresses that affect the melt reology and processability of the material and, thus, the quality of the finished product. To optimize the quality of the product made by the previous methods, the thermoformable material sheet should be stress-relieved prior to usage, a step that requires additional time, energy, manpower and ultimately cost.

Furthermore, another disadvantage is that the processes described above are neither automated nor truly continuous from the input of the raw material to the finished product, and typically require multiple manufacturing personnel, multiple heating and cooling, and other multiple steps that are unnecessary t o produce an expanded thermoformable honeycomb product. Obviously, the use of multiple personnel greatly increases the cost of manufacturing, together with the long product cycle times and energy loss.

Finally, the existing processes have inherent limitations in terms of volume throughput and capacity and the ability to scale-up to meet large customer demands. All the aforementioned processes are batch or semi-continuous processes and cannot produce volume production yields. At the same time, the built-in economic and energy disadvantages of these processes make them impossible to manufacture expanded thermoformable product at an economic level that helps to meet large customer requirements.

Therefore, there is a need for an improved method of continuously producing expanded thermoformable honeycomb materials that avoids the aforementioned disadvantages. In this regard, the present inventors have developed a unique continuous process, which integrates direct with the primary processing and forming of the raw material inputs, substantially reducing overall product cycle time, labor costs and energy consumption, while significantly enhancing volume production capacity and throughput. Only one or two members of the manufacturing team are required to oversee the entire operation from raw material to finished product of the thermoplastic, expanded honeycomb material.

### SUMMARY OF THE INVENTION

The present invention provides a cost-effective and energy efficient method for continuously producing expanded thermoformable honeycomb materials. This method encompasses the steps of: providing raw thermoformable, material (such as thermoplastic flake or pellets) into an extruder; heating the raw material in the extruder; extruding continuous sheet material of suitable gauge and width; edge trimming the continuous extruded sheet material while it is still hot to suitable widths; conveying this hot thermoformable continuous sheet and preheating it if necessary prior to conveying the continuous sheet into a coreformer having heated forming rolls or belts with an arrangement of holes or other geometries on its surface, expanding the heated thermoformable sheet material in this expansion region into honeycomb and transferring the expanded honeycomb through an array of cooling rolls or belts; and then cooling the expanded thermoformable honeycomb material so as to maintain its integrity and facilitate release from the cooling rolls or belts and cutting the expanded thermoformable honeycomb to the required length. The present invention eliminates the problem of removing moisture from hydrophilic materials since the temperature of the material is maximized and the transfer time between extruding and forming is minimized.

Continuous extruded sheet of thermoplastic material (such as high impact polystyrene, polycarbonate, acrylonitrile butadiene styrene, polypropylene-homo or co-polymer, low and high density polyethylene and a host of other thermoplastic materials) can be used in this process. These materials can be extruded utilizing co-extrusions, alloys, fiber/filler/nano reinforced polymers, flexible polymeric materials, recycled materials or variations and combinations of all of the above.

It is desirable to keep the continuous extruded sheet material as hot as possible prior to its entering the coreforming/expansion region so as to minimize the amount of energy used in re-heating it. The continuous extruded thermoplastic sheet should be only allowed to cool to the minimal temperature necessary to prevent it from gross distortions of shape during the brief transfer time from extruder to the coreforming region. Preheating of the continuous sheet may be utilized to maintain the sheet as hot as possible without distortion of the sheet. Once in the coreforming region, the continuous extruded thermoplastic sheet is heated to a temperature at which the material adhesively bonds to each forming surface. The continuous extruded thermoplastic sheet, which is between the forming surfaces is then heated to a temperature in the range of about 250° F. to 700° F., and the forming surfaces are thereafter slowly separated so as to affect an expansion of the cross-section of the thermoformable material to the desired thickness. After the expansion is complete, the expanded honeycomb is transferred to a cooling region where the expanded honeycomb is cooled to maintain its integrity and release from the region and finally cut into the appropriate length.

The forming surfaces which come into contact with the thermoformable material may have perforations thereon, thereby creating cells in the cross-section of the expanded thermoformable material during the expansion process. Alternatively, each set of forming surfaces may have either the same or different diameter perforations thus enabling the creation of expanded thermoformable honeycomb materials having different or the same cell cross-sections.

In one representation of the present invention, a preheat section utilizing heating rolls, an oven or other means of heating is situated between the extruder and the coreforming region. The preheat section accepts the hot, continuous extruded sheet material from the extruder and maintains it at a high temperature and then transfers it into the coreforming/expansion region comprised of heated forming rolls. This will ensure the efficient and cost-effective continuous production capability of the system, by minimizing any heat required to maintain the continuous sheet temperature and reducing the temperature difference that the continuous sheet must be brought up to prior to expansion. After the expansion process, the expanded honeycomb is transferred to a cooling region comprised of an array of cooling rolls which cool the product in order to maintain its integrity and facilitate its release from the rolls.

In another illustration of this invention, the extruder feeds the continuous extruded sheet material into a preheat/heated section comprised of continuous, heated belts that heat the sheet material prior to transferring it to the final forming/expansion region followed by transferring the expanded honeycomb into a cooling region. The continuous belts encompass the preheat section, heating/expansion section and the cooling region making the entire process continuous and self-contained.

In another embodiment of this invention, a control system, using computer(s) software, sensors, actuators, programmable logic controllers, is used to control the extrusion, temperature, rate of movement, preheating, expansion and cooling of the entire coreforming system, from raw material to finished product.

The present invention is continuous from raw material to finished product, i.e., a raw material is pre-formed into a continuous sheet, then transferred continuously through various preheating, heating, expansion and cooling regions, whereby an expanded thermoformable honeycomb material is produced about every two minutes.

Preferably, the present invention comprises a method for forming an expanded thermoformable honeycomb product comprising: providing thermoformable material to an extruder; heating the thermoformable material disposed in the extruder; extruding a heated thermoformable sheet formed of the thermoformable material; conveying the heated thermoformable sheet to a coreformer, the coreformer comprising a pair of upper and lower conveyor belts or rollers disposed on opposite surfaces of the heated sheet; heating the heated thermoformable sheet disposed in the coreformer to a temperature at which the heated thermoformable sheet adheres to the conveyor belts; and separating the conveyor belts, thereby forming the expanded thermoformable honeycomb product.

The method further comprises conveying the expanded thermoformable honeycomb product to a cooling region.

The thermoformable honeycomb product is formed either in a continuous mode or in a batch mode.

The thermoformable material is at least one material selected from the group consisting of: high impact polystyrene, polycarbonate, acrylonitrile butadiene styrene, homo-polymer polypropylene, co-polymer polypropylene, low density polyethylene, and high density polyethylene.

Preferably, the upper and/or lower conveyor belts or rollers comprises a plurality of perforations thereon for ventilation.

The thermoformable material further comprises at least one additive selected from the group consisting of: plastic, glass, mineral, carbon, ceramic, boron, wood, aramid, or metal fibers, carbon nanotubes or nanoclays, calcium carbonate, calcium silicate, calcium sulfate, aluminum silicate, magnesium silicate, alumina trihydrate, glass microspheres, carbon black, solid/liquid or paste pigments, silicon dioxide, flexible polymeric materials such as butadiene, acrylonitrile, and CTBN, recycled materials.

Optionally, the thermoformable material is a heterogeneous mixture and is extruded so that heated thermoformable sheet comprises a plurality of layers. The plurality of layers comprises a pair of outer layers comprising a first material and an inner layer comprising a second material, wherein the inner layer is disposed between the pair of outer layers.

Preferably the heated thermoformable sheet is preheated prior to being conveyed to the coreformer.

The present invention also pertains to a device for producing an expanded thermoformable honeycomb product, the device comprising: an extruder for forming a heated thermoformable sheet from thermoformable material; a coreformer comprising a pair of oppositely disposed upper and lower belts disposed about the heated thermoformable sheet, wherein the heated thermoformable sheet is heated to a temperature such that it adheres to the heated belts; and a separator that causes the expansion of the heated thermoformable sheet while disposed in the coreformer, thereby forming and expanded thermoformable product.

Other and further objects, advantages and features of the present invention will be understood by reference to the following specification in conjunction with the drawings, wherein like parts have been given like numbers.

### BRIEF DESCRIPTION OF THE DRAWINGS

FIG. 1 is a diagram of a system for continuously producing expanded thermoformable honeycomb materials, from raw material to finished product showing forming roll and cooling roll regions.

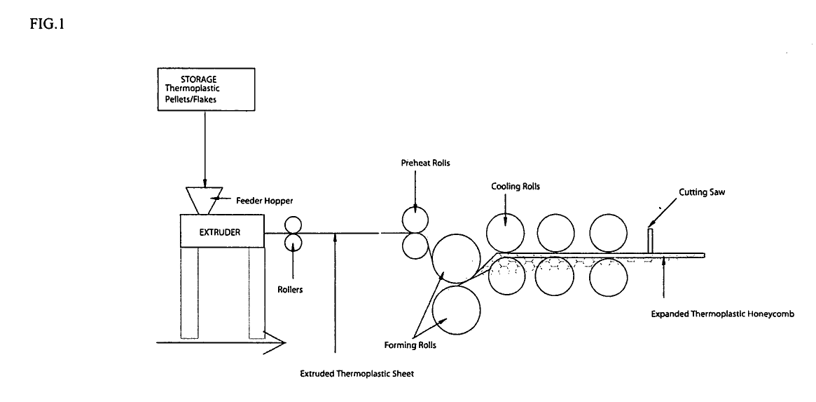

FIG. 2 is a diagram of the system for continuously producing expanded thermoformable honeycomb materials showing the use of a preheat region between the extruder and the coreforming region.

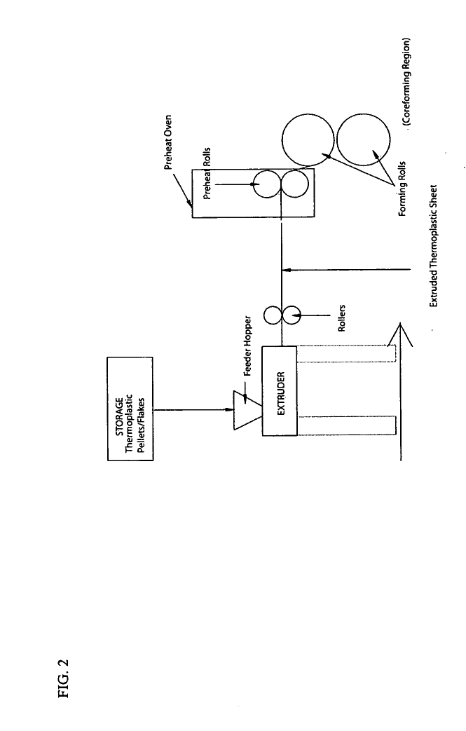

FIG. 3 is another diagram of a system for continuously producing expanded thermoformable honeycomb materials, from raw material to finished product showing continuous belts encompassing the preheat/heating, expansion and cooling regions.

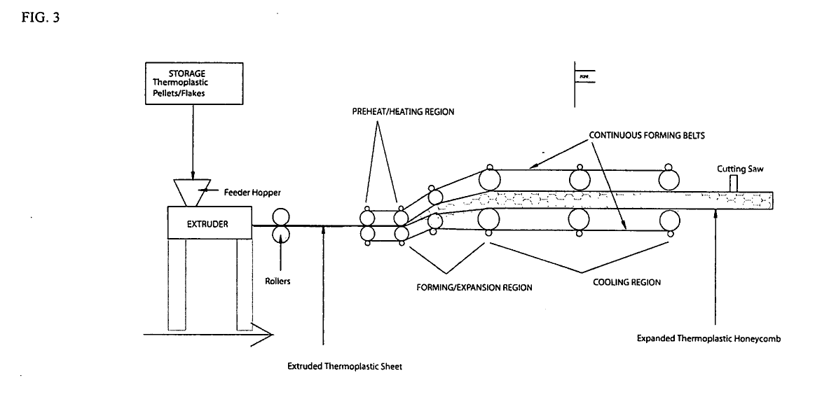

### DETAILED DESCRIPTION OF THE PREFERRED EMBODIMENT

Raw material, such as flakes or pellets of thermoplastic material, is fed into the extruder by means of a conveying device or hopper. Inside the extruder, the raw material is heated to a melt temperature at which the material becomes a viscous liquid. In this state, it is forced under pressure, typically by a screw pump mechanism, through a set of dies generally in the shape of a flat, continuous sheet. The present invention can form expanded materials from a variety of extruded sheet thicknesses with 0.080 inches to 0.250 inches being typical. By the time the material has been forced through the extruder dies into sheet form, it has cooled to approximately 200-500° F. depending on the type of thermoplastic, and, while it is still soft and flexible, it is no longer in a liquid state. It is moved forward on a conveyor device into either a preheat region or a preheat/heating region. In the present invention, the raw thermoplastic material goes through only one complete heating cycle instead of a minimum of two heating cycles as with the prior art.

After this point of the process, the present invention differs noticeably from the prior art. The sheet is not finished to a tight final thickness tolerance, or polished to create a desirable surface, or sealed. One major objective of the present invention is to keep the thermoformable plastic material at as high a temperature as possible without distortion of the continuous sheet. Instead of cooling the continuous sheet material as previously done in the prior art, the current invention maintains its heat as it moves forward into the heating/expansion region.

Once the continuous plastic sheet material is transferred into the coreforming/expansion region, the forming rolls or belts come into contact with the continuous plastic sheet material, under minimum pressure, and heats it up to forming temperatures of 250-700° F. so that it will adhere to the forming surfaces before the expansion process begins. There is a specific temperature range at which the continuous plastic sheet material will adhere to the forming surfaces through hot tack adhesion and if the temperature is below this temperature the material cannot be expanded into honeycomb since it will not adhere to the forming surfaces prior to being expanded. After the continuous plastic sheet material has been expanded into honeycomb, it is transferred into a cooling region comprised of either an array of cooling rolls or continuous belts which are sent back to the preheat/heating section of the process for continuous processing of the extruded sheet into expanded honeycomb.

One significant feature of this invention is that the thermoformable thermoplastic material sheet is not only preheated, if necessary before being expanded, but is not allowed to cool down from the heat of the original extrusion process from the raw material flakes or pellets. This is significant in that this reduces the temperature that the continuous extruded sheet must be heated to for expansion into honeycomb, thereby reducing energy costs.

Another significant feature of the present invention is its ability to utilize thermoformable sheet material with less stringent thickness tolerances, thus further reducing cost. Generally, extruded sheet materials go through a specific process to ensure tight thickness tolerances. Because the extruded materials are dedicated for use in the coreformer, and will be further heat processed, the initial tolerances of the extruded sheet need not be as stringent as typical extruded sheet products.

Another important characteristic of the present invention is that the preheat, heating/expansion and cooling regions are situated in extremely close proximity to each other in the process, reducing the time to transfer from one region to another, thus increasing efficiency and throughput of final product. In the previous art, product was made in either a batch process or in a quasi-shuttle process which was not truly continuous in nature and thus throughput was not optimized.

An additional feature of the present invention is the ability to increase throughput rates of the extruder through the coreformer by making the forming rolls larger, the cooling roll region longer or forming belts longer which add additional surface area for product to be expanded and cooled.

While we have shown and described several illustrations in accordance with our invention, it is to be clearly understood that the same are susceptible to numerous changes apparent to one skilled in the art. Therefore, we do not wish to be limited to the details shown and described but intend to show all changes and modifications which come within the scope of the appended claims.

What is claimed is:

1. A method for forming an expanded thermoformable honeycomb product comprising:
providing thermoformable material to an extruder;
heating said thermoformable material disposed in said extruder;
extruding a heated thermoformable sheet formed of said thermoformable material;
conveying said heated thermoformable sheet to a coreformer, said coreformer comprising a pair of upper and lower conveyor belts or rollers disposed on opposite surfaces of said heated sheet;
heating said heated thermoformable sheet disposed in said coreformer to a temperature at which said heated thermoformable sheet adheres to said conveyor belts; and
separating said conveyor belts, thereby forming said expanded thermoformable honeycomb product.

2. The method of claim 1, further comprising conveying said expanded thermoformable honeycomb product to a cooling region.

3. The method of claim 1, wherein said expanded thermoformable honeycomb product is formed either in a continuous mode or in a batch mode.

4. The method of claim 1, wherein said thermoformable material is at least one material selected from the group consisting of: high impact polystyrene, polycarbonate, acrylonitrile butadiene styrene, homo-polymer polypropylene, co-polymer polypropylene, low density polyethylene, and high density polyethylene.

5. The method of claim 1, wherein said upper and/or lower conveyor belts or rollers comprises a plurality of perforations thereon.

6. The method of claim 1, wherein said thermoformable material further comprises at least one additive selected from the group consisting of: plastic, glass, mineral, carbon, ceramic, boron, wood, aramid, or metal fibers, carbon nanotubes or nanoclays, calcium carbonate, calcium silicate, calcium sulfate, aluminum silicate, magnesium silicate, alumina trihydrate, glass microspheres, carbon black, solid/liquid or paste pigments, silicon dioxide, flexible polymeric materials such as butadiene, acrylonitrile, and CTBN, recycled materials.

7. The method of claim 1, wherein said thermoformable material is a heterogeneous mixture and is extruded so that heated thermoformable sheet comprises a plurality of layers.

8. The method of claim 7, wherein said plurality of layers comprises a pair of outer layers comprising a first material and an inner layer comprising a second material, wherein said inner layer is disposed between said pair of outer layers.

9. The method of claim 1, wherein said heated thermoformable sheet is preheated prior to being conveyed to said coreformer.

10. A device for producing an expanded thermoformable honeycomb product, said device comprising:
an extruder for forming a heated thermoformable sheet from thermoformable material;
a coreformer comprising a pair of oppositely disposed upper and lower belts disposed about said heated thermoformable sheet, wherein said heated thermoformable sheet is heated to a temperature such that it adheres to said heated belts; and
a separator that causes the expansion of said heated thermoformable sheet while disposed in said coreformner, thereby forming and expanded thermoformable product.

11. The device of claim 10, further comprising a cooler unit that cools said expanded thermoformable product.

12. The device of claim 10, further comprising a preheater disposed between said extruded and coreformer.

13. The device of claim 10, wherein said thermoformable material is at least one selected from the group consisting of: high impact polystyrene, polycarbonate, acrylonitrile butadiene styrene, homo-polymer polypropylene, co-polymer polypropylene, low density polyethylene, and high density polyethylene.

14. The device of claim 10, wherein said upper and/or lower conveyor belts or rollers comprises a plurality of perforations thereon.

15. The device of claim 10, wherein said expanded thermoformable honeycomb product is formed either in a continuous mode or in a batch mode.

16. The device of claim 10, wherein said thermoformable material further comprises at least one additive selected form the group consisting of: plastic, glass, mineral, carbon, ceramic, boron, wood, aramid, or metal fibers, carbon nanotubes or nanoclays, calcium carbonate, calcium silicate, calcium sulfate, aluminum silicate, magnesium silicate, alumina trihydrate, glass microspheres, carbon black, solid/liquid or paste pigments, silicon dioxide, flexible polymeric materials such as butadiene, acrylonitrile, and CTBN, recycled materials.

17. The device of claim 10, wherein said thermoformable material is a heterogeneous mixture and is extruded so that heated thermoformable sheet comprises a plurality of layers.

18. The device of claim 17, wherein said plurality of layers comprises a pair of outer layers comprising a first material and an inner layer comprising a second material, wherein said inner layer is disposed between said pair of outer layers.

19. A method for forming expanded thermoformable honeycomb materials, said method comprising:
conveying a heated thermoformable sheet to a coreformer, said coreformer comprising a pair of upper and lower conveyor belts or rollers disposed on opposite surfaces of said heated sheet;
heating said heated thermoformable sheet disposed in said coreformer to a temperature at which said heated thermoformable sheet adheres to said conveyor belts or rollers ; and
separating said conveyor belts or rollers, thereby forming said expanded thermoformable honeycomb product.
